(19) United States
(12) Patent Application Publication
(10) Pub. No.: US 2009/0327673 A1
(43) Pub. Date: Dec. 31, 2009

(54) ESTIMATOR, TABLE MANAGING DEVICE, SELECTING DEVICE, TABLE MANAGING METHOD, PROGRAM FOR ALLOWING COMPUTER TO EXECUTE THE TABLE MANAGING METHOD, AND RECORDING MEDIUM WHERE THE PROGRAM IS RECORDED

(75) Inventors: Norifumi Yoshimatsu, Fukuoka-shi (JP); Makoto Yoshida, Fukuoka-shi (JP)

Correspondence Address: TUROCY & WATSON, LLP, 127 Public Square, 57th Floor, Key Tower, CLEVELAND, OH, 44114, US

(73) Assignee: FUKUOKA INDUSTRY, SCIENCE & TECHNOLOGY FOUNDATION, Chuo-ku, Fukuoka-shi, Fukuoka (JP)

(21) Appl. No.: 12/089,635

(22) PCT Filed: Oct. 16, 2006
(86) PCT No.: PCT/JP2006/320547

§ 371 Date: Sep. 17, 2009

(30) Foreign Application Priority Data
Oct. 17, 2005 (JP) 2005-301104

(51) Int. Cl. G06F 9/38

(52) U.S. Cl. 712/240; 712/E09.045

(57) ABSTRACT

An estimator suitable for hot-path detection conducted while managing the history of the executed instructions is provided. A hot-path estimator (1) comprises a table in which branch instruction specifying information for specifying a branch instruction, the branch destination address of each executed branch instruction, the number of branches, and execution frequency information are treated as one entry and each piece of branch instruction specifying information corresponds to a predetermined number of entries, a history managing section (11) for selecting one of the processings of adding a new entry to the table, replacing one of the entries of the table, and not storing the information on the executed branch instructions in the table if the information on the executed branch instructions is not stored in the table, and a hot-path qualifying section (7) for outputting the instruction path searched for by a hot-path searching section (13) according to the table to the outside if the instruction path has been not detected.

### TECHNICAL FIELD

The present invention relates to an estimator, a table managing device, a selecting device, a table managing method, a program for allowing a computer to execute the table managing method, and a recording medium where the program is recorded. More particularly, the present invention relates to an estimator or the like which estimates an instruction path having high execution frequency out of instruction paths including a plurality of branch instructions.

### BACKGROUND ART

For example, a device disclosed in Patent Document 1 is known as a device which estimates a loop-structured path where execution frequency is high in execution of a program (hereinafter, referred to as “hot-path”) with high accuracy. Referring to FIGS. 13 to 15, a summary of an estimator disclosed in Patent Document 1 will be described.

FIG. 13 is a schematic block diagram of a hot-path estimator 101 disclosed in Patent Document 1. The hot-path estimator 101 includes a hardware assisting section (HW assisting section) 105, a software profiler section (SW profiler section) 107, and a buffer 109.

The HW assisting section 105 manages a table, and newly adds address information related to branch instructions in a table and counts the number of executions of the branch instructions when the branch instructions are executed by CPU 103. Furthermore, in the case where the table and counter overflow, the HW assisting section 105 informs the CPU 103; and the CPU 103 performs a delivering processing to the buffer 109 of the table.

The SW profiler section 107 performs a combining processing of the buffer 109 and the table, and estimates an instruction row (a hot-path) repeatedly executed with high frequency on the basis of the BH method. The BH method is a method which estimates a hot-path on the basis of histories such as addresses of branch instructions, addresses of branch destinations, and the number of branched times (or not branched times) by the branch instructions.

FIG. 14 is a diagram showing one example of a relationship of basic blocks and the number of executions of branch instructions executed by a processor core. The instruction row configuring a program is configured by the branch instructions for changing flow of program execution and other instructions. Then, the program can be partitioned to blocks configured by instructions other than the branch instructions and a final branch instruction seen from an address sequence; and the block is referred to as the basic block. In FIG. 14, marks A to G show the basic blocks, and numerical values represent the number of branches of the branch instructions. In the relationship of the basic blocks shown in FIG. 14, a loop-structured path of the basic blocks A, B, C, and F are detected as the hot-path.

FIG. 15 is a diagram showing one example of a table managed by the HW assisting section 105 shown in FIG. 13 in the case where the basic blocks are in the relationship shown in FIG. 14. In FIG. 15, BSA denotes a basic block start address that is a start address of the basic blocks; BIA denotes a branch instruction address that is an address of the branch instructions; BTA denotes a branch destination address that is an address of a branch destination; and COUNT is the number of executions of the branch instructions. The SW profiler section 107 shown in FIG. 13 performs an estimating processing of the hot-path on the basis of the table shown in FIG. 15 and the buffer 109.

[Patent Document 1] Japanese Unexamined Patent Application Publication No. 2005-92532

### DISCLOSURE OF THE INVENTION

### Problems to be Solved by the Invention

However, the hot-path estimator disclosed in Patent Document 1 saves information stored in the table by overflow of the table and count in the buffer 109. Therefore, a large capacity of buffers is required; and further, a processing at the CPU 103 is interrupted because the CPU 103 performs a saving processing to the buffer 109.

Furthermore, information of the table is saved in the buffer 109; and therefore, even information on the same branch instructions, information before saving is managed in the buffer 109 and information after saving is managed in the table, separately; and there is a possibility that information is stored at a plurality of locations in the buffer 109 if the information is saved several times. Therefore, when a hot-path estimating processing is performed by the SW profiler section 107, a combining processing with information saved in the table and the buffer 109 is required.

Further, the processing by the SW profiler section 107 is complicated and it is difficult to realize by hardware; and therefore, the processing is realized by software. There is a case that the processing is executed by the CPU 103; however, in such a case, the processing of the CPU is interrupted due to the table combining processing and the hot-path estimating processing.

Still further, the hot-path estimator 101 stores detected hot-path; however, if the same hot-path is redundantly detected, the same hot-path is redundantly stored; and therefore, a vast storage area for storing the detected hot-path is required.

In addition, such problems are not limited to the hot-path estimating processing; but there exist such problems even in a processing conducted while managing a history of differently executed instructions.

Consequently, an object of the present invention is to provide an estimator, a table managing device, a selecting device, a table managing method, a program for allowing a computer to execute the table managing method, a recording medium where the program is recorded, all of which adapt to a simplification of the processing conducted while managing histories of executed instructions.

### Means for Solving Problem

A first aspect of the invention is an estimator which estimates an instruction path having high execution frequency out of instruction paths including a plurality of branch instructions, the estimator including: a table in which branch instruction identifying information for identifying the branch instruction, a branch destination address of executed each branch instruction, the number of branches, and execution frequency information are treated as one entry, and each piece of the branch instruction identifying information corresponds to a predetermined number of entries; a history managing unit which selects one of the processings of adding the entry on the branch instruction identifying information and the branch destination address to the table, replacing one of the entries of the table with the entry on the branch instruction identifying information and the branch destination address, or not storing information on the branch instruction identifying information and the branch destination address in the table, on the basis of the execution frequency information of each entry corresponding to the branch instruction identifying information, in the case where the branch instruction identifying information and the branch destination address are not stored in the entry in determining whether or not the branch instruction identifying information of the executed branch instruction and the branch destination address of the executed branch instruction are stored in the entries corresponding to the branch instruction identifying information when the branch instruction is executed; a searching section which searches the instruction path on the basis of the information stored in the table; and a qualifying unit which determines whether or not the instruction path searched by the searching section is already detected, and outputs the instruction path to the outside when the searched instruction path has not been detected.

A second aspect of the invention is a table managing device which manages a table in which each execution basic block executed to a basic block of an instruction path to be executed, and basic block execution sequence associated information that is information related to a next basic block to be executed next to the each execution basic block are treated as one entry, the table having the number of entries which is a predetermined numbers or less; and the table managing device including a history managing unit which selects one of the processings of adding the entry on the execution basic block and the next basic block to the table, replacing one of the entries of the table with the entry on the execution basic block and the next basic block, or not storing information on the execution basic block and the next basic block in the table, on the basis of the information stored in the table, in the case where the entries are not registered in the table in determining whether or not the entries related to the executed execution basic block and the next basic block to be executed next to the execution basic block are registered in the table when the basic block is executed.

In addition, in the second aspect of the invention, the basic block execution sequence associated information may include a start address of the execution basic block and a start address of the next basic block. Furthermore, the basic block execution sequence associated information may include the start address of the next basic block, and the entry of the basic block execution sequence associated information may be accessed by an index address generated on the basis of the start address of the execution basic block.

A third aspect of the invention is the table managing device described in the second aspect of the invention, wherein the basic block execution sequence associated information includes execution frequency information showing execution frequency of the execution basic block and the next basic block; and the history managing unit selects a processing on the basis of the execution frequency information stored in the table when the basic block is executed.

A fourth aspect of the invention is the table managing device described in the second or third aspect of the invention, wherein the table treats the basic block execution sequence associated information as one entry and includes a plurality of sub-tables in which the same index address is given; and the history managing unit accesses the entries of the sub-tables using an index address generated on the basis of information for identifying the execution basic block.

A fifth aspect of the invention is an estimator which estimates an instruction path having high execution frequency out of instruction paths including a plurality of branch instructions, the estimator including: a plurality of sets of branch history tables which store a branch destination address of executed each branch instruction, a basic block start address that is the branch destination address of the previously executed branch instruction, and the number of branches and execution frequency information as one entry, and are accessible by the same index address; a branch history managing block which, when the branch instruction is executed, reads the entry of the branch history table by an index address generated on the basis of the basic block start address that is the branch destination address of the previously executed branch instruction, determines whether or not the read entry is one related to the branch destination address and the basic block start address of the executed branch instruction, updates the number of branches and the execution frequency information of the entry when any entry is related, and performs an updating processing of the entry on the basis of the execution frequency information of the read entry when any entry is not related; a plurality of sets of return branch history tables which store the branch destination address of the executed each branch instruction, the number of branches, and the execution frequency information as one entry, and are accessible by the same index address; a return branch history managing block which, when the branch instruction is executed, reads the entry of the each return branch history table by the index address generated on the basis of the basic block start address that is the branch destination address of the previously executed branch instruction in the case where the branch destination address of the executed branch instruction is smaller than the address of the branch instruction, determines whether or not the read entry is related to the branch destination address, performs a processing which updates the number of branches and the execution frequency information of the entry when any entry is related and a processing which directs start of path searching processing when the number of branches is larger than a threshold, and performs the updating processing of the entry on the basis of the execution frequency information of the read entry when any entry is not related; and a searching section which searches the instruction path on the basis of information stored in the branch history table if the start of the path searching processing is directed by the return branch history managing block.

A sixth aspect of the invention is a selecting device which selects an instruction path searched by a searching section and output the same, the selecting device including: a storing block which stores path identifying information showing the instruction path searched by the searching section; a comparing section which compares path identifying information for identifying the searched instruction path with path identifying information stored in the storing block when the instruction path is searched by the searching section; and an outputting section which outputs the searched instruction path to the outside by the searching section on the basis of a compared result of the comparing section, wherein, when the path identifying information showing the searched instruction path is not stored in the storing block, the comparing section makes the storing block store the path identifying information and the outputting section outputs the instruction path searched by the searching section to the outside, and when the path identifying information showing the searched instruction path is stored in the storing block, the comparing section does not make the storing block store the path identifying information and the outputting section does not output the instruction path searched by the searching section to the outside.

A seventh aspect of the invention is the selecting device described in the sixth aspect of the invention, wherein the instruction path includes a branch instruction; and the path identifying information includes information which distinguishes between the case where the branch instruction of the instruction path branches and the case where the branch instruction of the instruction path does not branch.

An eighth aspect of the invention is a table managing method which manages a table in which each execution basic block executed to a basic block of an instruction path to be executed and basic block execution sequence associated information that is information related to a next basic block to be executed next to the each execution basic block are treated as one entry, the table having the number of entries which is a predetermined numbers or less; and the table managing method including a table managing step which selects one of the processings of adding the entry on the execution basic block and the next basic block to the table, replacing one of the entries of the table with the entry on the execution basic block and the next basic block, or not storing information on the execution basic block and the next basic block in the table, on the basis of the information stored in the table, in the case where the entry are not registered in the table when a history managing unit determines whether or not the entries related to the executed execution basic block and the next basic block to be executed next to the execution basic block are registered in the table when the basic block is executed.

A ninth aspect of the invention is a program capable of allowing a table managing method described in the eighth aspect of the invention to be executed by a computer.

A tenth aspect of the invention is a recording medium capable of allowing a program described in the ninth aspect of the invention to be executed by a computer and to be recorded.

### EFFECTS OF THE INVENTION

According to the invention according to each claim of application concerned, information to be used in a processing is limited to one determined to be important, and is adapted to a simplification of a processing conducted while managing histories of executed instructions.

Furthermore, according to the invention according to claims 1 to 5 and claims 8 to 10 of application concerned, information to be stored in a table is limited, a saving processing to a buffer is not required, and a combining processing is not also required. Therefore, it becomes easy to realize by hardware different from a CPU, and the processing of the CPU is not interrupted.

Still furthermore, according to the invention according to claims 1, 3, 4, and 5 of application concerned, table management is performed by using update frequency information; and therefore, information with high importance is stored in the table, and is adapted to an increase in correctness of a processing using the table.

Further, according to the invention according to claims 1 and 4 of application concerned, it become possible to shorten a processing time by processing using a plurality of tables, for example, by processing processes for each table in parallel.

Still further, according to the invention according to claims 1, 6, and 7 of application concerned, output to the outside is executed except for redundantly detected one of the detected instruction paths; and therefore, overhead related to transfer is reduced and a storing storage area is reduced.

### BRIEF DESCRIPTION OF THE DRAWINGS

FIG. 1 is a schematic block diagram of a hot-path estimator 1 according to a preferred embodiment of the present invention.

FIG. 2 is a diagram showing one example of a branch history table managed by a branch history managing block 15 shown in FIG. 1.

FIG. 3 is a diagram showing outline of one example of branch history management in which a branch history managing block 15 shown in FIG. 1 performs using two sets of the branch history tables shown in FIG. 2.

FIG. 4 is a flow chart showing one example of the branch history management in which the branch history managing block 15 shown in FIG. 1 performs using a plural number of the branch history tables shown in FIG. 2.

FIG. 5 is a diagram showing one example of a branch history table managed by a return branch history managing block 17 shown in FIG. 1.

FIG. 6 is a flow chart showing one example of an operation of the return branch history managing block 17 shown in FIG. 1.

FIG. 7 is a flow chart showing one example of an operation of a hot-path searching section 13 shown in FIG. 1.

FIG. 8 is a graph showing an example of hot-paths detected by execution of ghostscript.

FIG. 9 is a graph showing an example of hot-paths detected by the preferred embodiment of the present invention of the hot-paths detected in FIG. 8.

FIGS. 10(a) and 10(b) are diagrams showing one example of hot-path path signature information used in a detecting processing by a hot-path qualifying unit 7 shown in FIG. 1.

FIG. 11 is a diagram showing one example of allocation of each bit of path signature to branch instructions of basic blocks.

FIG. 12 is a schematic block diagram of the hot-path qualifying unit 7 shown in FIG. 1.

FIG. 13 is a schematic block diagram of a known hot-path estimator 101.

FIG. 14 is a diagram showing one example of a relationship of basic blocks and the number of executions of branch instructions executed by a processor core.

FIG. 15 is a diagram showing one example of a table managed by an HW assisting section 105 shown in FIG. 13 in the case of the relation between the basic blocks shown in FIG. 14.

### DESCRIPTION OF REFERENCE NUMERALS

1 Hot-path estimator
5 Hot-path detecting unit
7 Hot-path qualifying unit
11 History managing section
13 Hot-path searching section
15 Branch history managing block
17 Return branch history managing block

### BEST MODE FOR CARRYING OUT THE INVENTION

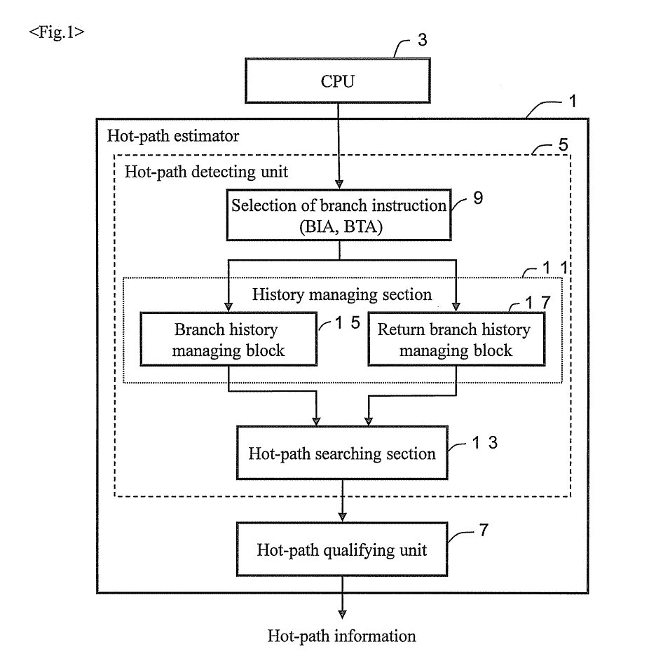

FIG. 1 is a schematic block diagram of a hot-path estimator 1 according to a preferred embodiment of the present invention.

Referring to FIG. 1, a hot-path estimator 1 includes a hot-path detecting unit 5 and a hot-path qualifying unit 7. The hot-path detecting unit 5 has a branch instruction selecting section 9, a history managing section 11, and a hot-path searching section 13. The history managing section 11 has a branch history managing block 15 and a return branch history managing block 17.

The branch instruction selecting section 9 selects a branch instruction of instructions executed by a CPU 3, and obtains a branch instruction address (BIA) that is an address of the branch instruction and a branch destination address (BTA) that is an address of a branch destination.

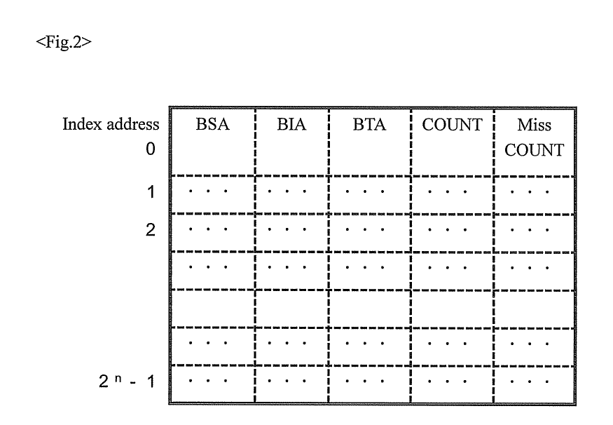

The branch history managing block 15 sets the BIA, BTA, and previous branch destination address obtained by the branch instruction selecting section 9 as a basic block start address (BSA), and manages branch history information of the branch instruction using a branch history table exemplified in FIG. 2.

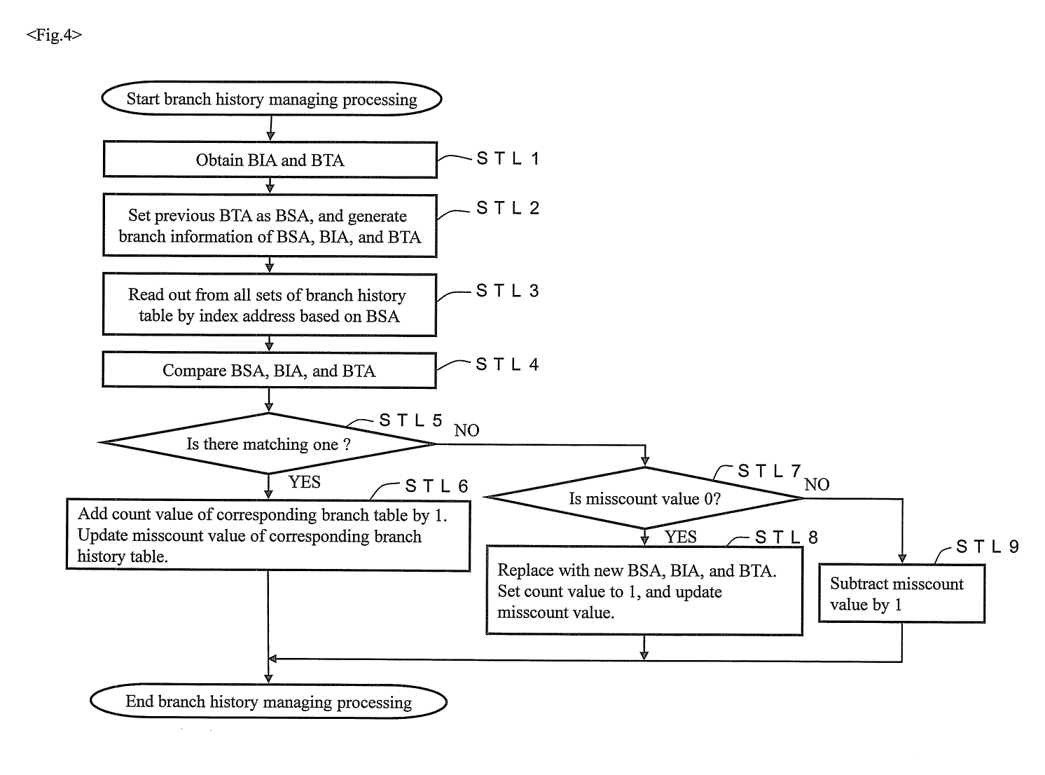

The return branch history managing block 17 manages the number of branches (COUNT) or the like in the case where the BTA obtained by the branch instruction selecting section 9 is smaller than the BIA, using a return branch history table exemplified in FIG. 5.

The hot-path searching section 13 searches an instruction path using the branch history table exemplified in FIG. 2.

The hot-path qualifying unit 7 determines whether or not hot-path information searched by the hot-path searching section 13 is redundantly detected, and outputs the hot-path information to the outside when the hot-path information is not redundantly detected.

Subsequently, the branch history managing block 15 shown in FIG. 1 will be described with reference to FIGS. 2 to 4.

FIG. 2 is a diagram showing one example of the branch history table managed by the branch history managing block 15 shown in FIG. 1. The example of the branch history table shown in FIG. 2 is one in which the basic block start address (BSA), the branch instruction address (BIA), the branch destination address (BTA), the number of branches (COUNT), and a miscount value (Miss COUNT) are treated as one entry by 2ⁿ index addresses.

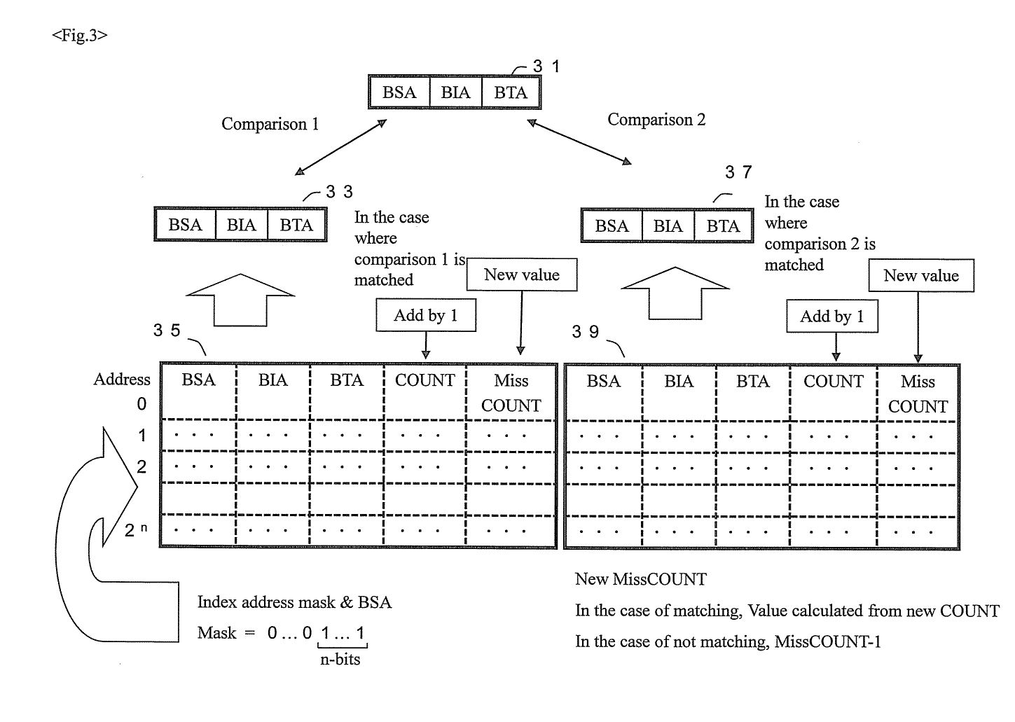

Subsequently, an example of branch history management in which the branch history managing block 15 shown in FIG. 1 performs using the branch history table shown in FIG. 2 will be described using FIGS. 3 and 4.

FIG. 3 is a diagram showing outline of one example of the branch history management in which the branch history managing block 15 shown in FIG. 1 performs using two sets of the branch history tables shown in FIG. 2. Referring to FIG. 3, one example of the branch history management in which the branch history managing block 15 shown in FIG. 1 performs using two sets of the branch history tables shown in FIG. 2 will be described. In what follows, two sets of tables are referred to as set 0 and set 1, respectively.

Referring to FIG. 3, the branch history managing block 15 shown in FIG. 1 sets the previous BTA as the BSA, and generates branch information 31 that is a group of the BSA, BIA, and BTA by the BSA and the BIA and BTA obtained by the branch instruction selecting section 9 shown in FIG. 1.

Next, the branch history managing block 15 shown in FIG. 1 obtains branch information 33 that is a group of the BSA, BIA, and BTA by accessing a branch history table 35 of the set 0 using low n bits of the BSA; and similarly, the branch history managing block 15 obtains branch information 37 that is a group of the BSA, BIA, and BTA by accessing a branch history table 39 of the set 1.

Next, the branch history managing block 15 shown in FIG. 1 compares the branch information 31 with the branch information 33 and the branch information 37; and if the branch information 31 is matched with one of the branch information 33 and the branch information 37, the number of branches (COUNT) corresponding to the matched branch information is increased by 1, and the miscount value is set as a value calculated from the new number of branches. In the case where the branch information 31 is not matched with both the branch information 33 and the branch information 37, it is determined whether or not the corresponding miscount value is 0; and if there is one whose miscount value is 0, a row to which the branch history table corresponds is replaced with new BSA, BIA, and BTA; the count value is set as 0 and the miscount value is updated; and other miscount value is decreased by 1. (In the case where there is a plurality of ones whose miscount value is 0, any table is updatable, for example, one table is updated and the other table is not updated.) If there is not one whose miscount value is 0, the miscount value corresponding to each branch history table is decreased by 1. (The branch information 31 is neither stored in the branch history table 35 nor in the branch history table 37.)

As described above, the branch history managing block 15 shown in FIG. 1 performs branch history management in the case of using two sets of the branch history tables. In the example shown in FIG. 3, the index address is generated by the low n bits of the BSA (basic block start address), and there is a possibility that a start address of a different basic block corresponds to the same index address. According to the example shown in FIG. 3, with reference to information of a branch destination of the branch instruction corresponding to the same index address, it is expected that more frequently performed two ones are managed by the index address corresponding to two sets of the tables.

Subsequently, referring to FIG. 4, the operation of branch history management in which the branch history managing block 15 shown in FIG. 1 performs using a plurality of the tables shown in FIG. 2 will be described. FIG. 4 is a flow chart showing one example of the branch history management in which the branch history managing block 15 shown in FIG. 1 performs using a plurality of sets of the branch history tables shown in FIG. 2.

Referring to FIG. 4, the branch history managing block 15 shown in FIG. 1 obtains a BIA and a BTA obtained by the branch instruction selecting section 9 shown in FIG. 1 (step STL1 shown in FIG. 4); and the branch history managing block 15 shown in FIG. 1 sets the previous BTA as a BSA and generates branch information of the BSA, BIA, and BTA (step STL2 shown in FIG. 4). Next, the branch history managing block 15 shown in FIG. 1 reads the branch information of the BSA, BIA, and BTA out from all sets of the branch history table by an index address based on the BSA (step STL3 shown in FIG. 4).

Next, the branch information of the BSA, BIA, and BTA generated in step STL2 shown in FIG. 4 is compared with the branch information of the BSA, BIA, and BTA read in step STL3 shown in FIG. 4 (step STL4 shown in FIG. 4); and it is determined whether or not there is a matching one (step ST5 shown in FIG. 4). If there is a matching one, a count value of the corresponding branch history table is increased by 1, and a miscount value of the corresponding branch history table is updated from a new count value to a calculated value (step STL6 shown in FIG. 4); and the process shown in FIG. 4 is ended. If there is not a matching one, it is determined whether or not there is one whose miscount value is 0 (step ST7 shown in FIG. 4). If there is one whose miscount value is 0, it is replaced with new BSA, BIA, and BTA; the count value is set to 1, and the miscount value is updated (step ST8 shown in FIG. 4); and the process shown in FIG. 4 is ended (in the case where there is a plurality of ones whose miscount value is 0, for example, one table is updated, and the other table is not updated.). If there is not one whose miscount value is 0 (that is, all of the miscount values is positive integer), the miscount value is decreased by 1 (step ST9 shown in FIG. 4); and the process shown in FIG. 4 is ended.

As described above, the branch history managing block shown in FIG. 1 performs branch history management in the case of using a plurality of branch history tables; as in the example shown in FIG. 3, with reference to the branch instruction corresponding to the same index address of the branch history table, it is expected that more frequently performed branch destination information is managed.

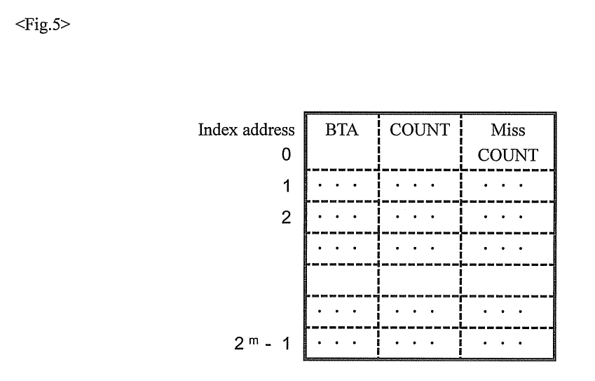

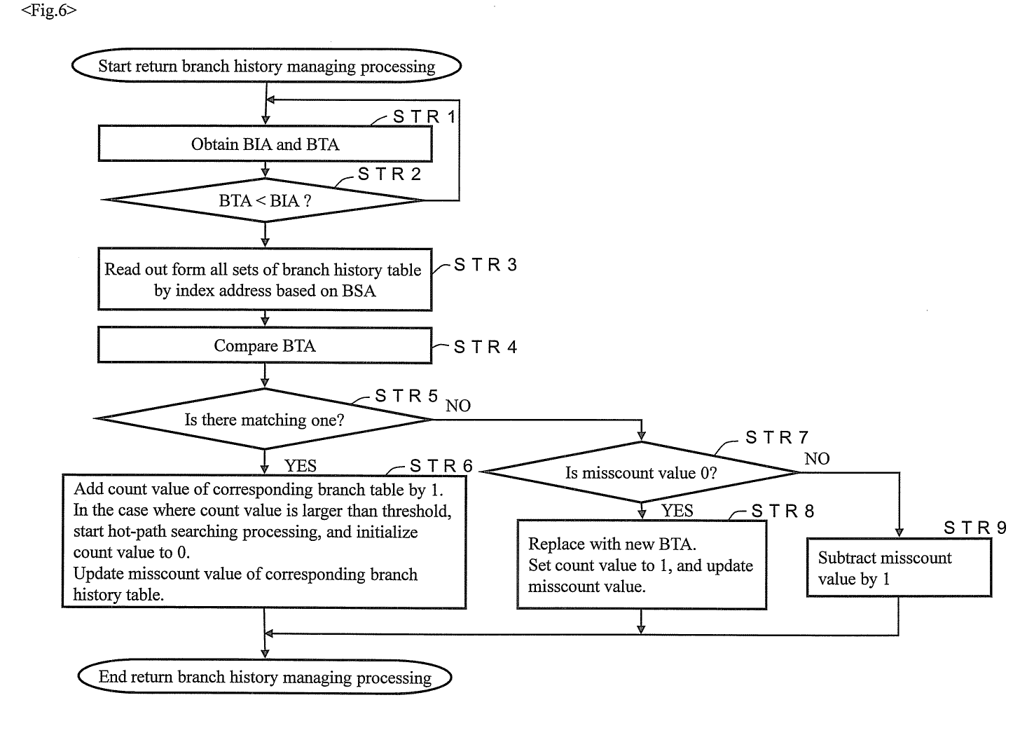

Subsequently, referring to FIGS. 5 and 6, the return branch history managing block 17 shown in FIG. 1 will be described.

FIG. 5 is a diagram showing one example of a branch history table managed by the return branch history managing block 17 shown in FIG. 1. The example of a return branch history table shown in FIG. 5 is one in which a branch destination address (BTA), the number of branches (COUNT), and a miscount value (Miss COUNT) are treated as one entry by 2^{m} index addresses.

Subsequently, referring to FIG. 6, the operation of return branch history management in which the return branch history managing block 17 shown in FIG. 1 performs using a plurality of the tables shown in FIG. 5 will be described. FIG. 6 is a flow chart showing one example of branch history management in which the return branch history managing block 17 shown in FIG. 1 performs using a plurality of sets of the return branch history tables shown in FIG. 5.

Referring to FIG. 6, the return branch history managing block 17 shown in FIG. 1 obtains a BIA and a BTA obtained by the branch instruction selecting section 9 shown in FIG. 1 (step STR1 shown in FIG. 6).

Next, the return branch history managing block 17 shown in FIG. 1 compares the BTA with the BIA, and in the case where the BTA is smaller than the BIA (in the case where there is a possibility that a basic block of a branch destination is one which is previously processed), a process of step STR3 shown in FIG. 6 is performed; if not so, the process is returned to step STR1 shown in FIG. 6 (step STR2 shown in FIG. 6).

In step STR3 shown in FIG. 6, the return branch history managing block 17 shown in FIG. 1 sets the previous BTA as a BSA, and the BSA is read out from all sets of the return branch history table by an index address based on the BSA.

Next, the return branch history managing block 17 shown in FIG. 1 compares the BTA obtained in step STR1 shown in FIG. 6 with the BTA read in step STR3 shown in FIG. 6 (step STR4 shown in FIG. 6), and determines whether or not there is a matching one (step STR5 shown in FIG. 6). If there is the matching one, a process of step STR6 shown in FIG. 6 is performed; and if there is not the matching one, subsequent process after step STR7 shown in FIG. 6 is performed.

In step STR6 shown in FIG. 6, the return branch history managing block 17 shown in FIG. 1 increases a count value of the corresponding return branch history table by 1; in the case where the count value is larger than a threshold, a hot-path searching processing by the hot-path searching section 13 shown in FIG. 1 is started and the count value is initialized to 0; and a miscount value of the corresponding return branch history table is updated. Then, the process shown in FIG. 6 is ended.

In step STR7 shown in FIG. 6, the return branch history managing block 17 shown in FIG. 1 determines whether or not there is one whose miscount value is 0. If there is one whose miscount value is 0, it is replaced with a new BTA; the count value is set to 1 and the miscount value is updated (step STR8 shown in FIG. 6); and the process shown in FIG. 6 is ended. If there is not one whose miscount value is 0, the miscount value is subtracted by 1 (step STR9 shown in FIG. 6); and the process shown in FIG. 6 is ended.

Subsequently, referring to FIG. 7, the process of the hot-path searching section 13 shown in FIG. 1 will be described. FIG. 7 is a flow chart showing one example of the operation of the hot-path searching section 13 shown in FIG. 1.

Referring to FIG. 7, the hot-path searching section shown in FIG. 1 registers a value of a BTA in a hot-path start address (step STS1 shown in FIG. 7), generates an index address on the basis of the BTA, and reads a branch history table (step STS2 shown in FIG. 7).

The hot-path searching section 13 shown in FIG. 1 compares the BTA with a read BSA (step STS3 shown in FIG. 7). The hot-path searching section 13 shown in FIG. 1 performs subsequent process after step STR5 shown in FIG. 7 if there is a matching one, and ends searching if there is not the matching one.

In step STS5 shown in FIG. 7, it is determined whether or not the BSA is matched in a plurality of sets; if matched in the plurality of sets, a count value is compared and the BSA corresponding to a large count value is selected as the next branch destination (step STS6 shown in FIG. 7); and a process of step STS7 shown in FIG. 7 is performed. In the case of not matching in the plurality of sets, the process of step STS7 shown in FIG. 7 is performed.

In step STS7 shown in FIG. 7, the hot-path searching section 13 shown in FIG. 1 determines whether or not a branch depth exceeds the maximum value. In this case, a hot-path can be represented by a branch destination address in branch instructions configuring the hot-path, and the number of the branch instructions is referred to as the branch depth in the hot-path. The hot-path searching section 13 shown in FIG. 1 ends searching if the branch depth exceeds the maximum value; and if not so, a process of step STS8 shown in FIG. 7 is performed.

In step STS8 shown in FIG. 7, the hot-path searching section 13 shown in FIG. 1 determines whether or not the branch destination address BTA read in step STS2 shown in FIG. 7 is matched with the hot-path start address (step STS8 shown in FIG. 7); if not matched, the process is returned to step STS2 shown in FIG. 7; and if matched, the resultant is outputted to the hot-path qualifying unit 7 shown in FIG. 1 as the hot-path (step STS9 shown in FIG. 7), and the process shown in FIG. 7 is ended.

Subsequently, referring to FIGS. 8 to 12, a detecting processing of hot-paths redundantly detected by the hot-path qualifying unit 7 shown in FIG. 1 will be described.

FIG. 8 is a graph showing an example of hot-paths detected by execution of ghostscript. The ghostscript is a program widely used in printing apparatuses such as a printer, and the program sets character information and image information described in a form of a postscript as an input, and converts to information in a form printable by each printing apparatus. An instruction row highly frequently executed in the program is different depending on character information and image information that are to be inputted; and therefore, information obtained by the estimator according to the present invention can be used for optimization of program execution. In the graph shown in FIG. 8, a horizontal axis shows the number of instruction executions; and a vertical axis shows hot-paths to be detected. In the graph shown in FIG. 8, for example, when the number of executions exceeds 40,000,000 times, there is a case where the hot-paths are redundantly detected as the hot-paths around values of 15, 20, and 90 in the vertical axis are repeatedly detected. The hot-path qualifying unit 7 shown in FIG. 1 detects hot-path information to be redundantly detected so as not to allow the information to be transferred to the outside; and accordingly, overhead related to the transfer of the hot-path information is reduced, and a storage area for storing the hot-path information is reduced.

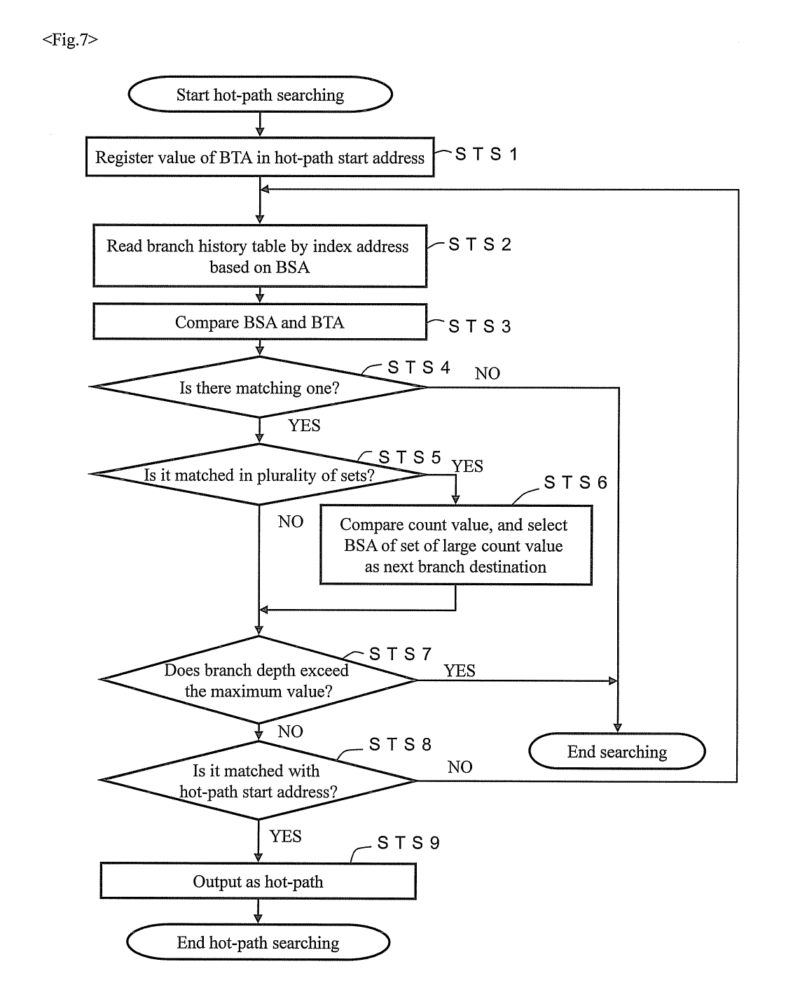

FIG. 9 is a graph showing an example of hot-paths detected by the preferred embodiment of the present invention of the hot-paths detected in FIG. 8. As shown in FIG. 9, according to the present invention, it becomes possible to detect hot-paths without redundant hot-paths.

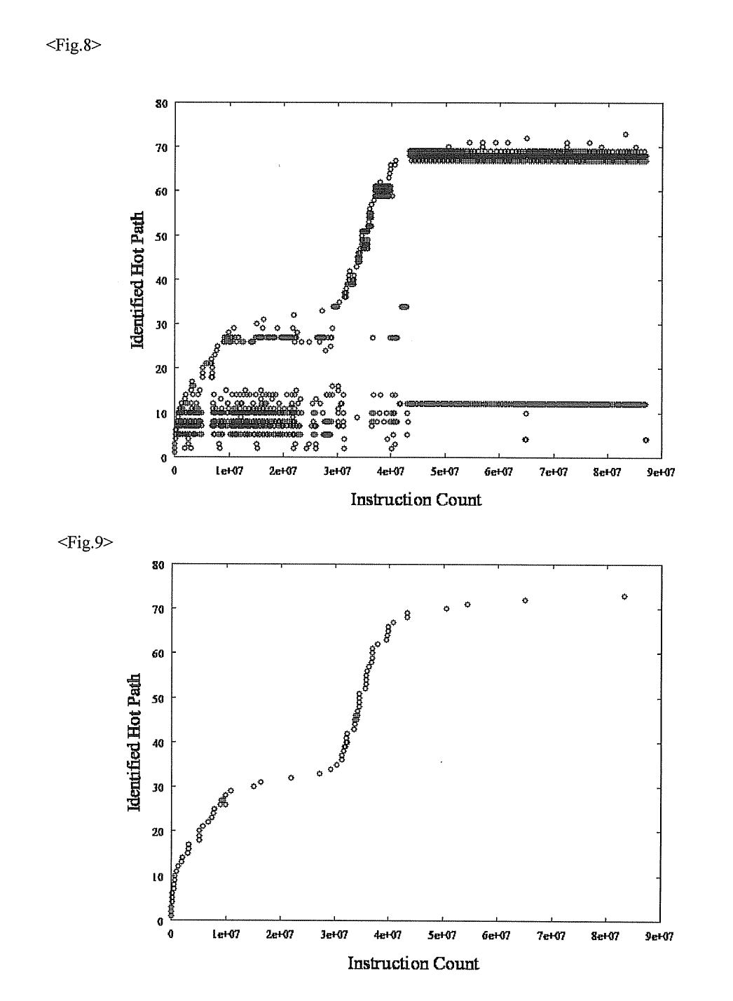

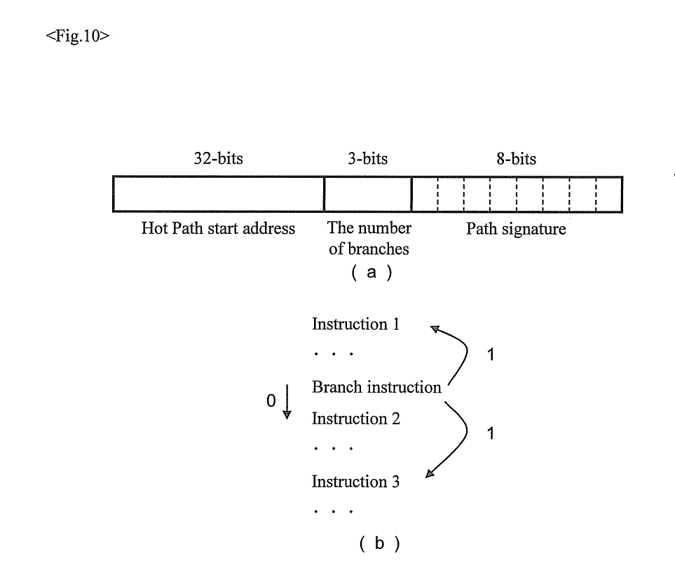

FIGS. 10(a) and 10(b) are diagrams showing one example of hot-path path signature information used in the detecting processing by the hot-path qualifying unit 7 shown in FIG. 1. As shown in FIG. 10(a), hot-path path signature information has a hot-path start address (BSA) of 32 bits, the number of branches of 3 bits, and path signature of 8 bits. For example, as shown in FIG. 10(b), respective bits of the path signature are 0 in the case where the branch instruction does not branch (that is, in the case of executing the next address instruction), and 1 in the case where the branch instruction branches. The effective number of branches of the respective bits of the path signature is shown. Such path signature information is made in the hot-path detecting processing.

Subsequently, referring to FIG. 11, information showing the respective bits of the path signature shown in FIGS. 10(a) and 10(b) will be described. FIG. 11 is a diagram showing one example of allocation of the respective bits of the path signature to branch instructions of basic blocks; and basic blocks A to G are allocated by addresses in alphabetical order. Referring to FIG. 11, for example, the respective bits of the path signature are allocated by 0 in the case where the basic block B is executed next to the basic block A; and allocated by 1 in the case where the basic block D is executed next to the basic block A. As for other basic blocks, similarly, 0 is allocated in the case where the next basic block is executed next; and 1 is allocated in the case where other basic block is executed next. It becomes possible to identify instruction paths including branch instructions by using such path signature.

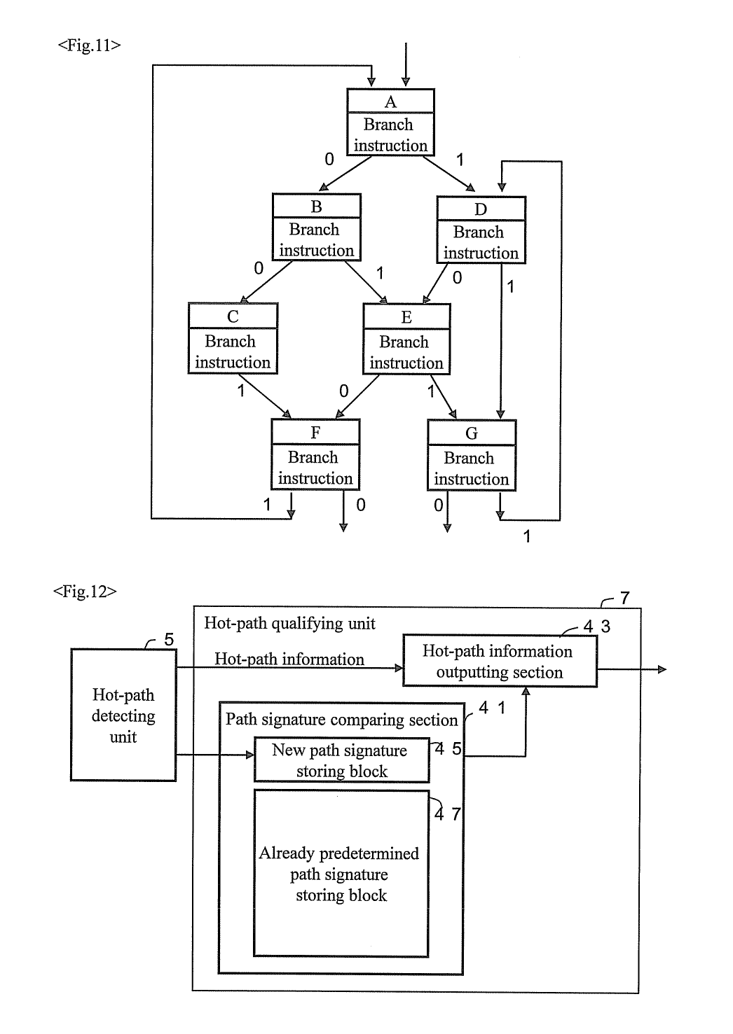

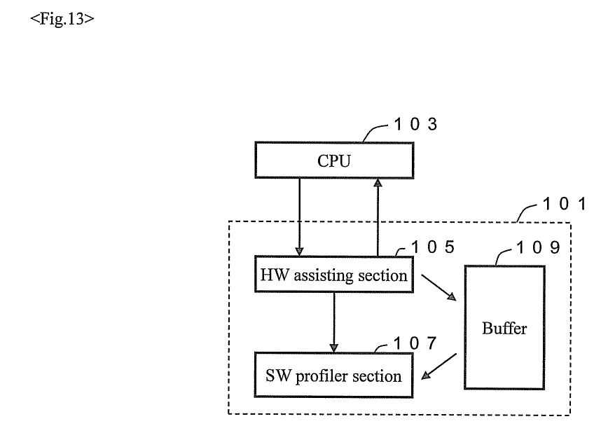

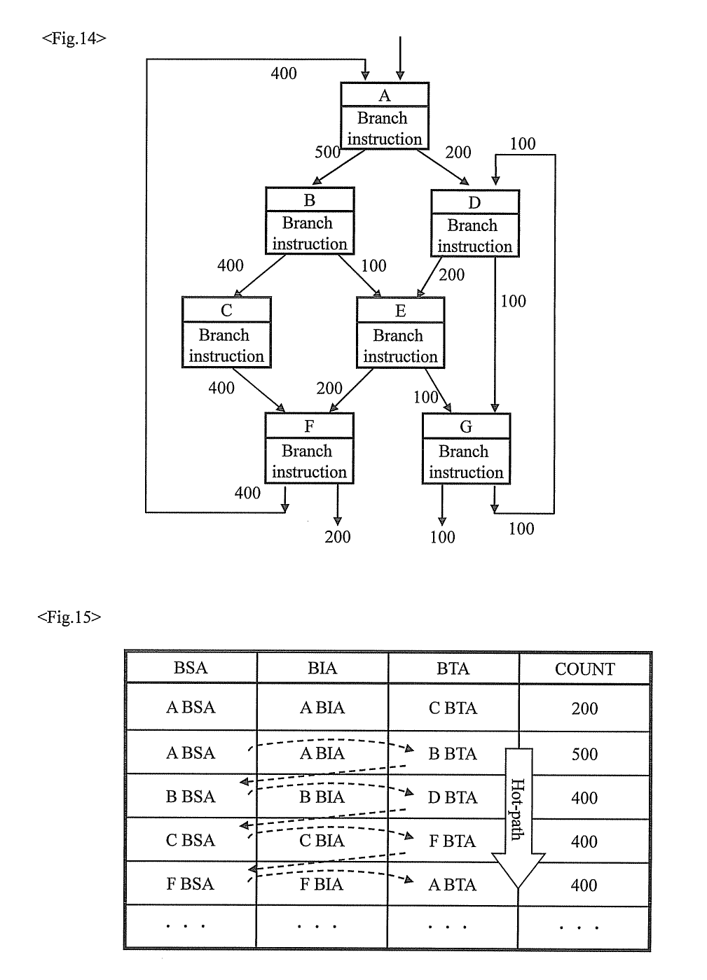

Subsequently, referring to FIG. 12, one example of the operation of the hot-path qualifying unit 7 shown in FIG. 1 will be described. FIG. 12 is a schematic block diagram of the hot-path qualifying unit 7 shown in FIG. 1. In FIG. 12, the hot-path qualifying unit 7 includes a path signature comparing section 41 and a hot-path information outputting section 43; and the path signature comparing section 41 includes a new path signature storing block 45 and an already predetermined path signature storing block 47.

The path signature comparing section 41 shown in FIG. 12 stores path signature corresponding to a hot-path detected by the hot-path detecting unit 5 into the new path signature storing block 45, and compares the path signature stored in the new path signature storing block 45 with path signature stored in the already predetermined path signature storing block 47. In the case where the path signature stored in the new path signature storing block 45 is not matched with the path signature stored in the already predetermined path signature storing block 47, the path signature comparing section 41 shown in FIG. 12 allows hot-path information detected by the hot-path detecting unit 5 to be outputted to the hot-path information outputting section 43 so as to store the path signature stored in the new path signature storing block 45 into the already predetermined path signature storing block 47. In this case, the already predetermined path signature storing block 47 holds the predetermined number of entries (for example, 16 entries); and when path signature is newly added, a processing such as replacing with the most unused entry is performed in the case where path signatures of the number of already predetermined entries are stored. The path signature comparing section 41 shown in FIG. 12 allows the hot-path information not to be outputted to the outside in the case where new path signature is stored in the already predetermined path signature storing block.

As described above, the hot-path qualifying unit 7 shown in FIG. 12 detects the hot-path information to be redundantly detected so as not to allow the information to be transferred to the outside; and accordingly, overhead related to the transfer of the hot-path information is reduced, and a storage area for storing the hot-path information is reduced.

1. An estimator which estimates an instruction path having high execution frequency out of instruction paths including a plurality of branch instructions, the estimator comprising:
a table in which branch instruction identifying information for identifying the branch instruction, a branch destination address of executed each branch instruction, the number of branches, and execution frequency information are treated as one entry, and each piece of the branch instruction identifying information corresponds to a predetermined number of entries;
a history managing unit which selects one of the processings of adding the entry on the branch instruction identifying information and the branch destination address to the table, replacing one of the entries of the table with the entry on the branch instruction identifying information and the branch destination address, or not storing information on the branch instruction identifying information and the branch destination address in the table, on the basis of the execution frequency information of each entry corresponding to the branch instruction identifying information, in the case where the branch instruction identifying information and the branch destination address are not stored in the entry in determining whether or not the branch instruction identifying information of the executed branch instruction and the branch destination address of the executed branch instruction are stored in the entries corresponding to the branch instruction identifying information when the branch instruction is executed;
a searching section which searches the instruction path on the basis of the information stored in the table; and
a qualifying unit which determines whether or not the instruction path searched by the searching section is already detected, and outputs the instruction path to the outside when the searched instruction path has not been detected.

2. A table managing device which manages a table in which each execution basic block executed to a basic block of an instruction path to be executed, and basic block execution sequence associated information that is information related to a next basic block to be executed next to the each execution basic block are treated as one entry,
the table having the number of entries which is a predetermined numbers or less; and
the table managing device including a history managing unit which selects one of the processings of adding the entry on the execution basic block and the next basic block to the table, replacing one of the entries of the table with the entry on the execution basic block and the next basic block, or not storing information on the execution basic block and the next basic block in the table, on the basis of the information stored in the table, in the case where the entries are not registered in the table in determining whether or not the entries related to the executed execution basic block and the next basic block to be executed next to the execution basic block are registered in the table when the basic block is executed.

3. The table managing device described in claim 2,
wherein the basic block execution sequence associated information includes execution frequency information showing execution frequency of the execution basic block and the next basic block; and
the history managing unit selects a processing on the basis of the execution frequency information stored in the table when the basic block is executed.

4. The table managing device described in claims 2 or 3,
wherein the table treats the basic block execution sequence associated information as one entry and includes a plurality of sub-tables in which the same index address is given; and
the history managing unit accesses the entries of the sub-tables using an index address generated on the basis of information for identifying the execution basic block.

5. An estimator which estimates an instruction path having high execution frequency out of instruction paths including a plurality of branch instructions, the estimator comprising:
a plurality of sets of branch history tables which store a branch destination address of executed each branch instruction, a basic block start address that is the branch destination address of the previously executed branch instruction, and the number of branches and execution frequency information as one entry, and are accessible by the same index address;
a branch history managing block which, when the branch instruction is executed, reads the entry of the branch history table by an index address generated on the basis of the basic block start address that is the branch destination address of the previously executed branch instruction, determines whether or not the read entry is one related to the branch destination address and the basic block start address of the executed branch instruction, updates the number of branches and the execution frequency information of the entry when any entry is related, and performs an updating processing of the entry on the basis of the execution frequency information of the read entry when any entry is not related;
a plurality of sets of return branch history tables which store the branch destination address of the executed each branch instruction, the number of branches, and the execution frequency information as one entry, and are accessible by the same index address;
a return branch history managing block which, when the branch instruction is executed, reads the entry of the each return branch history table by the index address generated on the basis of the basic block start address that is the branch destination address of the previously executed branch instruction in the case where the branch destination address of the executed branch instruction is smaller than the address of the branch instruction, determines whether or not the read entry is related to the branch destination address, performs a processing which updates the number of branches and the execution frequency information of the entry when any entry is related and a processing which directs start of path searching processing when the number of branches is larger than a threshold, and performs the updating processing of the entry on the basis of the execution frequency information of the read entry when any entry is not related; and
a searching section which searches the instruction path on the basis of information stored in the branch history table if the start of the path searching processing is directed by the return branch history managing block.

6. A selecting device which selects an instruction path searched by a searching section and output the same, the selecting device comprising:
a storing block which stores path identifying information showing the instruction path searched by the searching section;
a comparing section which compares path identifying information for identifying the searched instruction path with path identifying information stored in the storing block when the instruction path is searched by the searching section; and
an outputting section which outputs the searched instruction path to the outside by the searching section on the basis of a compared result of the comparing section,
wherein, when the path identifying information showing the searched instruction path is not stored in the storing block, the comparing section makes the storing block store the path identifying information and the outputting section outputs the instruction path searched by the searching section to the outside, and when the path identifying information showing the searched instruction path is stored in the storing block, the comparing section does not make the storing block store the path identifying information and the outputting section does not output the instruction path searched by the searching section to the outside.

7. The selecting device described in claim 6,
wherein the instruction path includes a branch instruction; and
the path identifying information includes information which distinguishes between the case where the branch instruction of the instruction path branches and the case where the branch instruction of the instruction path does not branch.

8. A table managing method which manages a table in which each execution basic block executed to a basic block of an instruction path to be executed and basic block execution sequence associated information that is information related to a next basic block to be executed next to the each execution basic block are treated as one entry,
the table having the number of entries which is a predetermined numbers or less; and
the table managing method including a table managing step which selects one of the processings of adding the entry on the execution basic block and the next basic block to the table, replacing one of the entries of the table with the entry on the execution basic block and the next basic block, or not storing information on the execution basic block and the next basic block in the table, on the basis of the information stored in the table, in the case where the entry are not registered in the table when a history managing unit determines whether or not the entries related to the executed execution basic block and the next basic block to be executed next to the execution basic block are registered in the table when the basic block is executed.

9. A program capable of allowing a table managing method described in claim 8 to be executed by a computer.

10. A recording medium capable of allowing a program described in claim 9 to be executed by a computer and to be recorded.
